(19) United States
(12) Patent Application Publication
(10) Pub. No.: US 2026/0160120 A1
(43) Pub. Date: Jun. 11, 2026

(54) BOX CORNERS FOR FENESTRATION SYSTEMS

(71) Applicant: Arconic Technologies LLC, Pittsburgh, PA (US)

(72) Inventors: Leonard WILCOX, Suwanee, GA (US); Kaushal H. PATEL, Lawrenceville, GA (US)

(73) Assignee: Arconic Technologies LLC, Pittsburgh, PA (US)

(21) Appl. No.: 19/322,400

(22) Filed: Sep. 8, 2025

Related U.S. Application Data
(60) Provisional application No. 63/729,806, filed on Dec. 9, 2024.

(51) Int. Cl. E06B 3/96; E04B 1/76; E04B 2/90; E06B 3/984

(52) U.S. Cl. CPC E06B 3/9616; E04B 1/7641; E04B 2/90; E06B 3/984

(57) ABSTRACT

A fenestration system includes a first wall section extending in a first direction and including a first glazing unit attached to a first mullion, a second wall section extending in a second direction different from the first direction and including a second glazing unit attached to a second mullion, and a box corner assembly operatively coupling the first and second glazing units. The box corner assembly includes first and second corner extrusions, each corner extrusion including a base that provides opposing apex and tail ends, the apex end of each corner extrusion being operatively coupled to each other, and a strut including a head operatively coupled to the first and second corner extrusions, and a stem extending from the head and being operatively coupled to the first and second mullions.

### BACKGROUND

Commercial buildings, such as storefronts and high-rise buildings, have a building façade or “fenestration assembly” that constitutes the outside or external face of the building. Example fenestration assemblies include curtain walls, panel façades, window walls, and window walls with vents (e.g., pivoting, sliding, and swinging windows). Along with the roof, fenestration assemblies are one of the most important elements of a building since they act as the primary barrier against external weather elements, such as rain, snow, wind, frost, sun, etc., which could damage the interior and overall integrity of the building.

A curtain wall is made up of a series of unitized window panels or pre-glazed units (e.g., “glazing units”) that are attached to or “hung” on the exterior of the building from various building structures, such as floor slabs. Because the curtain wall glazing units carry no structural load beyond their own dead load weight, they can be made of lightweight materials. In contrast, window walls typically span between floors of a building, from the top of a slab of one floor to the underside of a slab of a second floor. Sill and head receptors are installed between vertically adjacent slabs, and a series of glazing units are subsequently received by the sill and head receptors and secured thereto to progressively build the window wall laterally.

When encountering an external or internal corner of the building, the glazing units of curtain walls and window walls on a given floor must transition from one wall section extending in one direction to a second wall section extending in a second direction from the first direction (e.g., a 90°corner transition). A corner mullion or “box corner” is commonly used to facilitate the transition between the adjacent wall sections and helps secure the first and second wall sections together.

Ideally, the box corner is easy to manufacture and install, but should also be designed to make a consistent aesthetic view as it transitions between the adjacent wall sections.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Embodiments disclosed herein include a fenestration system that includes a first wall section extending in a first direction and including a first glazing unit attached to a first mullion, a second wall section extending in a second direction different from the first direction and including a second glazing unit attached to a second mullion, and a box corner assembly interposing and operatively coupling the first and second glazing units. The box corner assembly includes first and second corner extrusions, each corner extrusion including a base that provides opposing apex and tail ends, the apex end of each corner extrusion being operatively coupled to each other, the tail end of the base of the first corner extrusion being operatively coupled to the first mullion, and the tail end of the base of the second corner extrusion being operatively coupled to the second mullion, and a strut including a head operatively coupled to the first and second corner extrusions, and a stem extending from the head and being operatively coupled to the first and second mullions. In a further embodiment, the first and second wall sections form part of a storefront framing system, a window wall system, or a curtain wall system. In another further embodiment, the first and second directions are angularly offset from each other by about 45° to about 185°. In another further embodiment, the box corner assembly comprises an outside box corner and the first and second wall sections converge on the box corner assembly in a convex and outwardly protruding geometry. In another further embodiment, the box corner assembly comprises an inside box corner and the first and second wall sections converge on the box corner assembly in a concave and inwardly protruding geometry. In another further embodiment, the apex end of each corner extrusion is operatively coupled to each other using a gasket arranged at an interface between the apex ends. In another further embodiment, at least one of the first and second mullions comprises a split mullion. In another further embodiment, at least one of the first and second mullions comprises a composite profile including an outer section, an inner section, and a thermal break that interposes and operatively couples the outer and inner sections. In another further embodiment, each tail end provides an extension configured to be received within a receptacle provided by the corresponding first or second mullion. In another further embodiment, the fenestration further includes a first gasket arranged at an interface between the receptacle of the first mullion and the tail end of the first corner extrusion, and a second gasket arranged at an interface between the receptacle of the second mullion and the tail end of the second corner extrusion. In another further embodiment, each corner extrusion provides a lateral projection that terminates at a foot, and wherein each foot is engageable with the head of the strut, and one or more mechanical fasteners secure the foot to the head. In another further embodiment, the fenestration system further includes a lateral tab extending from each corner extrusion and sized to be received within a corresponding channel defined by the head, wherein the foot and the lateral tab of each corner extrusion engage different, non-parallel surfaces of the head, thereby providing positive engagement that temporarily attaches each corner extrusion to the strut. In another further embodiment, the stem includes a thermal break positioned along its length. In another further embodiment, wherein the stem includes a first flange receivable within a first receptacle of the first mullion, and a second flange receivable within a second receptacle of the second mullion, and wherein receiving the first and second flanges in the first and second receptacles, respectively, operatively couples the stem to the first and second mullions.

Embodiments disclosed herein may further include a box corner assembly for a fenestration system, the box corner assembly including a first corner extrusion that includes a first base having opposing apex and tail ends, and a first lateral projection extending from the first base and terminating at a first foot, a second corner extrusion that includes a second base having opposing apex and tail ends, the apex end of each base being operatively coupleable to each other, the tail end of the first base being operatively coupleable to a first wall section of the fenestration system, and the tail end of the second base being operatively coupleable to a second wall section of the fenestration system, and a second lateral projection extending from the second base and terminating at a second foot, and a strut including a head operatively coupleable to the first and second feet, and a stem extending from the head. In a further embodiment, the box corner assembly further includes one or more gaskets arranged at an interface between the apex ends of each base to operatively couple the apex end of the first base to the apex end of the second base. In another further embodiment, the box corner assembly further includes one or more mechanical fasteners to secure the foot of each lateral projection to the head. In another further embodiment, the box corner assembly further includes one or more first protrusions provided at an interface between the first foot and the head, and one or more second protrusions provided at an interface between the second foot and the head. In another further embodiment, the first corner extrusion provides a first lateral tab extending from the first lateral projection and sized to be received within a first channel defined by the head, wherein the second corner extrusion provides a second lateral tab extending from the second lateral projection and sized to be received within a second channel defined by the head, and wherein the first foot and the first lateral tab engage different, non-parallel surfaces of the head, and the second foot and the second lateral tab engage different, non-parallel surfaces of the head, thereby providing positive engagement that temporarily attaches each corner extrusion to the strut. In another further embodiment, the stem includes a thermal break positioned along its length.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is an isometric view of an example fenestration system that may incorporate the principles of the present disclosure.

FIG. 2 is a cross-sectional top view of an example box corner assembly, according to one or more embodiments of the present disclosure.

FIG. 3 is a cross-sectional top view of another example box corner assembly, according to one or more additional embodiments of the present disclosure.

### DETAILED DESCRIPTION

The present disclosure is related to fenestration systems and, more particularly, to box corner assemblies that operatively couple opposing wall sections of a fenestration system at a corner.

Embodiments disclosed herein describe a fenestration system that include a first wall section extending in a first direction and including a first glazing unit attached to a first mullion, and a second wall section extending in a second direction different from the first direction and including a second glazing unit attached to a second mullion. A box corner assembly is provided to operatively couple the first and second glazing units. The box corner assembly may include first and second corner extrusions, where each corner extrusion includes a base that provides opposing apex and tail ends. The apex end of each corner extrusion may be operatively coupled to each other. The tail end of the base of the first corner extrusion may be operatively coupled to the first mullion, and the tail end of the base of the second corner extrusion may be operatively coupled to the second mullion. A strut includes a head operatively coupled to the first and second corner extrusions, and a stem extends from the head and may be operatively coupled to the first and second mullions.

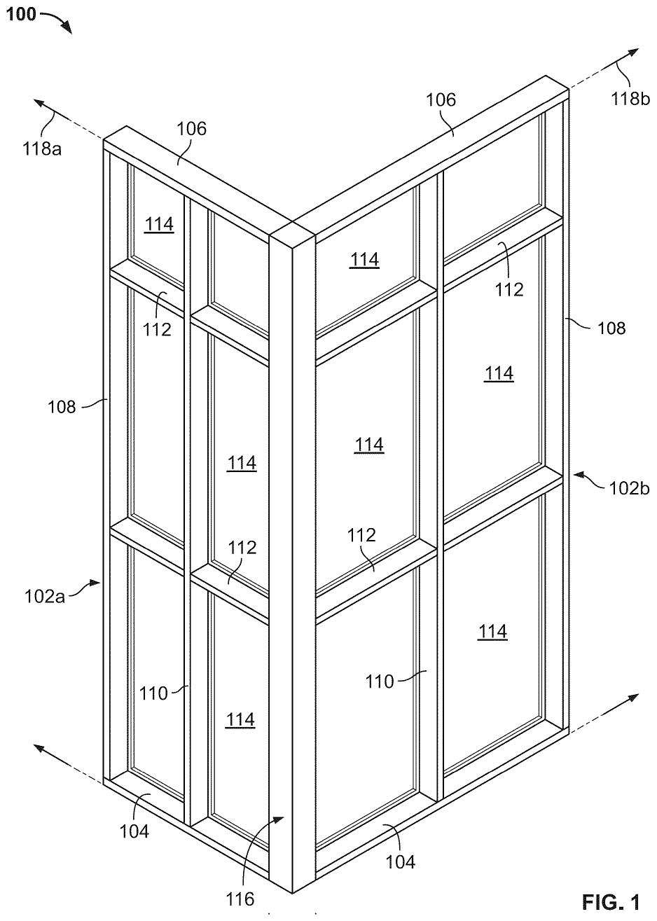

FIG. 1 is an isometric view of an example fenestration system 100 that may incorporate the principles of the present disclosure. The fenestration system 100 shown in FIG. 1 is a window wall system, but could alternatively comprise other types of fenestration systems, such as a storefront framing system, windows or curtain wall system. The fenestration system 100 (referred to hereafter as “the system 100”) may be suitable for installation in large commercial buildings, such as a skyscrapers, but could alternatively be applied to smaller commercial or residential buildings, such as a storefront, without departing from the scope of the disclosure.

As illustrated, the system 100 includes an assembly of a plurality of shop-assembled glazing units, shown in FIG. 1 as glazing units 102a and 102b. In applications where the system 100 comprises a window wall, the glazing units 102a,b are arranged between upper and lower floor slabs (not visible).

Each glazing unit 102a,b may be substantially similar in construction. For example, as illustrated, each glazing unit 102a,b includes a sill 104, a head 106, and at least one mullion 108 extending vertically between the sill 104 and the head 106. The sill 104, the head 106, and the vertical mullions 108 may each comprise a rigid extrusion made of aluminum, an aluminum alloy, or other metals and metal alloys. In some applications, as illustrated, one or both of the glazing units 102a,b may further include one or more intermediate mullions 110 extending between the sill 104 and the head 106, and one or more transoms 112 extending horizontally between the mullions 108 and intermediate mullion(s) 110.

The combination of the sill 104, the head 106, the vertical mullions 108, the intermediate mullions 110, and the transoms 112 cooperatively encompass and secure a plurality of panels 114 on all four sides to form a solid structure. In some applications, the intermediate mullions 110 and the transoms 112 may be omitted, and in such embodiments, the sill 104, the head 106, and the vertical mullions 108 will cooperatively encompass and secure a single panel 114 on all four sides. Each panel 114 may comprise, for example, a pane of window glass, polycarbonate, or another clear, translucent, tinted, or opaque material.

The first and second glazing units 102a,b each form part of distinct wall sections of the system 100 that meet at a corner mullion or “box corner” 116. More specifically, the first glazing unit 102a forms part of a first wall section 118a that includes the first glazing unit 102a and a plurality of glazing units (not shown) operatively coupled to and extending in series from (or to) the first glazing unit 102a. Similarly, the second glazing unit 102b forms part of a second wall section 118b that includes the second glazing unit 102b and a plurality of glazing units (not shown) operatively coupled to the second glazing unit 102b and extending in series from (or to) the second glazing unit 102a. The first and second wall sections 118a,b are represented in FIG. 1 as arrows extending from the first and second glazing units 102a,b, respectively, but would otherwise comprise a plurality of glazing units similar in some respects to the glazing units 102a,b.

The first wall section 118a (including the first glazing unit 102a) extends in a first direction and terminates at one side of the box corner 116, and the second wall section 118b (including the second glazing unit 102b) extends in a second direction angularly offset from the first direction and terminates at another side of the box corner 116. Accordingly, the first and second wall sections 118a,b extend from the box corner 116 in different directions (e.g., different planes). In some embodiments, the first and second wall sections 118a,b may be angularly offset from each other by 90°, but could alternatively be angularly offset by other angular magnitudes. For example, the wall sections 118a,b may be angularly offset from each other by about 45° to about 185°, without departing from the scope of the disclosure.

The box corner 116 facilitates the transition between the first and second wall sections 118a,b and helps secure the first and second glazing units 102a,b to each other. In the illustrated application, the box corner 116 comprises an “outside” box corner where the first and second wall sections 118a,b converge on the box corner 116 in a convex or outwardly protruding geometry. In other applications, however, the box corner 116 may comprise an “inside” box corner where the first and second wall sections 118a,b converge on the box corner 116 in a concave or inwardly protruding geometry, without departing from the scope of the disclosure. In embodiments where the system 100 is a window wall system, and similar to the glazing units 102a, b, the box corner 116 also extends between the upper and lower floor slabs (not visible).

According to embodiments of the present disclosure, the box corner 116 comprises and otherwise forms part of a box corner assembly that mechanically attaches the first and second glazing units 102a,b, and thereby facilitates a structural transition between the first and second wall sections 118a,b. In some embodiments the box corner assembly may include three distinct pieces or component parts that are assembled to form the box corner assembly. The assembled box corner assembly provides enhanced structural strength (wind load deflection) as compared to conventional box corners because it includes an internal extrusion (e.g., a “strut”) that adds to the strength of the box corner. The box corner assembly can also be installed from the interior of the building, thereby not requiring outside support during installation, which is the common installation process for conventional box corners. Moreover, the box corner assembly does not require access holes for attachment screws for inside corners, as compared to conventional box corner assemblies. Lastly, the design of the box corner assembly helps to reduce the sealant line on the outside and inside corners, which improves appearance and reduces labor.

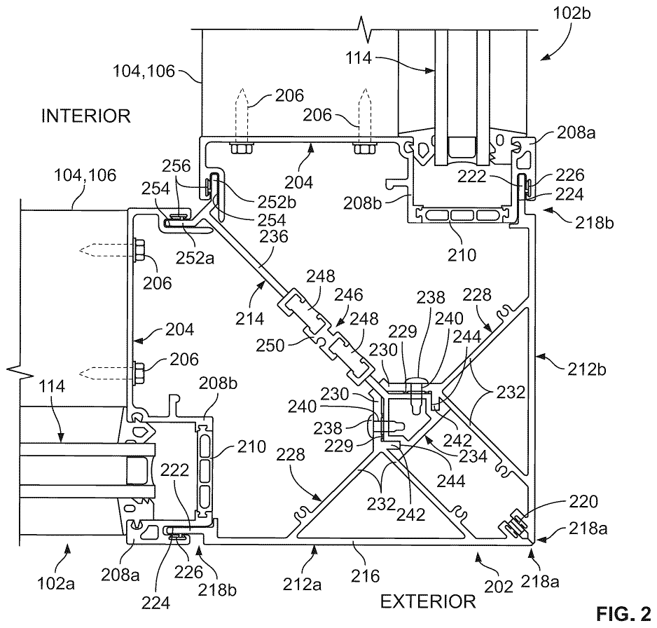

FIG. 2 is a cross-sectional top view of an example box corner assembly 202, according to one or more embodiments of the present disclosure. The box corner assembly 202 may be the same as or similar to the box corner 116 of FIG. 1. Consequently, the box corner assembly 202 may form part of the system 100 (FIG. 1) and, therefore, may be operatively coupled to the first and second glazing units 102a,b, which include a corresponding one or more panels 114. The box corner assembly 202 comprises an “outside” box corner, where the panels 114 are arranged adjacent to and otherwise facing the exterior of the building, as opposed to the interior, and the glazing units 102a,b converge on the box corner assembly 202 in a convex or outwardly protruding geometry.

As illustrated, each glazing unit 102a,b includes and otherwise terminates at a mullion 204 that can be operatively coupled to the sill 104 and/or the head 106 using one or more mechanical fasteners 206. In some embodiments, as illustrated, the mullion 204 may comprise a “split” mullion. The “split” mullion 204 may comprise half of a vertical mullion 110 (FIG. 1), and is commonly required in pre-glazed or unitized framing systems. The mullion 204 may be made of a variety of rigid materials including, but not limited to, a metal (e.g., aluminum, steel, iron), a composite material (e.g., pultruded fiberglass), or any combination thereof. In some applications, as illustrated, the mullion 204 may comprise a composite profile. More specifically, the mullion 204 may include a first or “outer” section 208a and a second or “inner” section 208b, and the outer and inner sections 208a,b may be operatively coupled and otherwise separated by a thermal break 210. The thermal break 210 may be made of a thermally non-conductive material, such as a polymer (e.g., polyamide or polyurethane) or an elastomer, and may therefore interrupt thermal transfer between the outer and inner sections 208a,b.

In some embodiments, the box corner assembly 202 may be made up of a plurality of component parts, shown as a first corner extrusion 212a, a second corner extrusion 212b, and a strut 214 that helps operatively couple the first and second corner extrusions 212a,b. The first and second corner extrusions 212a,b and the strut 214 may be made of a variety of rigid materials including, but not limited to, a metal (e.g., aluminum, steel, iron), a composite material (e.g., pultruded fiberglass), or any combination thereof. In other embodiments, the box corner assembly 202 may comprise a single component part. In such embodiments, the first and second corner extrusions 212a,b and the strut 214 may be formed as a single monolithic part, without departing from the scope of the disclosure.

The corner extrusions 212a,b are symmetric and otherwise mirror images of each other. As illustrated, each corner extrusion 212a,b includes a base 216 that provides a first or “apex” end 218a and a second or “tail” end 218b. The apex ends 218a of each corner extrusion 212a,b may be operatively coupled to each other to form the outer corner point of the box corner assembly 202. In some embodiments, as illustrated, one or more gaskets 220 may interpose an interface between the apex ends 218a. The gasket 220 may not only seal the interface between the opposing apex ends 218a, but may also help operatively couple the opposing apex ends 218a together.

The tail end 218b of each base 216 may be operatively coupled to an adjacent mullion 204 of the first or second glazing units 102a,b. More specifically, an extension 222 may be provided at the tail end 218b of each base 216 and may be configured to be received within a corresponding groove or receptacle 224 defined in each mullion 204. More specifically, the outer section 208a of the mullion 204 corresponding to the first glazing unit 102a provides a receptacle 224 configured to receive the extension 222 of the base 216 pertaining to the first corner extrusion 212a, and the outer section 208a of the mullion 204 corresponding to the second glazing unit 102b provides a receptacle 224 configured to receive the extension 222 of the base 216 pertaining to the second corner extrusion 212b. Receiving the extensions 222 in the corresponding receptacles 224 may help secure the box corner assembly 202 to the glazing panels 102a,b, and may further help operatively coupled the first glazing panel 102a to the second glazing panel 102b. In some embodiments, as illustrated, one or more gaskets 226 may be arranged at the interface between the tail end 218b and the corresponding receptacles 222. Receiving the extensions 222 within the corresponding receptacles 224 provides ease of installation of the box corner assembly 202 without requiring fasteners, and also creates positive alignment of the corner assembly in relation to the glazed panels while allowing for movement due to thermal expansion/contraction. Moreover, the gaskets 226 help prevent air or water infiltration.

Each corner extrusion 212a,b may further include a lateral projection 228 extending from the base 216 and terminating at a foot 230. In some embodiments, as illustrated, each lateral projection 228 may include two or more supports 232 that extend from the base 216 at different locations and converge toward one another. In such embodiments, the foot 230 extends from the supports 232 at the point where the feet 230 converge and meet.

As illustrated, the strut 214 includes a head 234 and a stem 236 extending from the head 234. The corner extrusions 212a,b may each be operatively coupled to the strut 214 at the head 234. More specifically, one or more mechanical fasteners 238 may extend through the foot 230 of each corner extrusion 212a,b and penetrate the head 234. In some embodiments, each foot 230 may define an aperture 240 that receives the corresponding mechanical fastener 238, and the mechanical fastener 238 may be driven through (penetrate) the head 234. In at least one embodiment, the mechanical fasteners 238 may comprise self-tapping screws or the like.

In some embodiments one or more bumps or protrusions 242 may be provided at the interface between the feet 230 and the head 234. In the illustrated embodiment, the protrusions 242 are defined on the inner surface of each foot 230, but could alternatively be provided on the outer surface of the head 234, or on both the foot 230 and the head 234, without departing from the scope of the disclosure. The protrusions 242 may facilitate an offset at the interface between the head 234 and the adjacent foot 230. In some embodiments, as illustrated, two protrusions 242 may be provided at the interface between the head 234 and the adjacent foot 230, and the corresponding mechanical fastener 238 extends between the two protrusions 242. The protrusions 242 may help provide positive alignment of the parts prior to driving the fasteners 238, then supplement the structural properties of the fasteners 238.

In some embodiments, the corner extrusions 212a,b may be positively engaged with the head 234 before the two component parts are secured together using the mechanical fasteners 238. More specifically, the design and geometry of the corner extrusions 212a,b (i.e., the lateral protrusions 228 and the feet 230) and the head 234 may allow the corner extrusions 212a,b to be removably or temporarily attached to the head 234, which may prove advantageous in allowing an installer to manipulate and handle the box corner assembly 202 as a monolithic part. In at least one embodiment, as illustrated, a lateral tab 242 may extend from each lateral protrusion 228 and may be sized to be received within (e.g., keyed into) a corresponding channel 244 defined by the head 234. The lateral tab 242 may extend, for example, from the foot 230 at or near the location where the supports 232 converge and meet each other, but the lateral tab 242 may alternatively extend from other locations on the corner extrusions 212a,b, without departing from the scope of the disclosure.

The head 234 may exhibit a generally polygonal geometry (e.g., square, rectangular, pentagonal, etc.), and portions of the corner extrusions 212a,bmay extend about (along) two or more non parallel surfaces of the head 234. More specifically, as illustrated, the lateral tab 242 and the foot 230 of each corner extrusion 212a,b extend in different directions and engage different surfaces of the head 234, thereby contacting and extending along two or more non-parallel surfaces of the head 234. Receiving the lateral tab 242 within the corresponding channel 244, in combination with the foot 230 engaging a different surface of the head 234 provides “positive engagement” and otherwise helps temporarily couple the corner extrusions 212a,b to the stem 214 at the head 234.

The stem 236 extends from the head 234 in a generally straight direction and, in some embodiments, may include a thermal break 246 positioned along its length. In some embodiments, as illustrated, the thermal break 246 comprises two interconnected pour and debridge (P&D) thermal break portions 248 interconnected with a bridge 250. The PND thermal break portions 248 may be made of urethane and the bridge 250 may be made of aluminum, for example. The thermal break 246 may prove advantageous in preventing conduction of thermal energy loss between the exterior and interior portions of the box corner assembly 220.

The stem 236 terminates in first and second flanges 252a and 252b extending in different (e.g., opposite) directions from the stem 236. The thermal break 246 generally interposes the head 234 and the flanges 252a,b. The first and second flanges 252a,b may be configured to be received within corresponding grooves or receptacles 254 defined in each mullion 204. More specifically, the inner section 208b of the mullion 204 corresponding to the first glazing unit 102a provides a receptacle 254 configured to receive the first flange 252a, and the inner section 208b of the mullion 204 corresponding to the second glazing unit 102b provides a receptacle 254 configured to receive the second flange 252b. Receiving the flanges 252a,b in the corresponding receptacles 254 may help secure the box corner assembly 202 to the glazing panels 102a,b, and may further help operatively coupled the first glazing panel 102a to the second glazing panel 102b. In some embodiments, as illustrated, one or more gaskets 256 may be arranged at the interface between the flanges 252a,b and the corresponding receptacles 254.

Receiving the flanges 252a,b in the receptacles 254 provides ease of installation of the box corner assembly 202 without requiring fasteners, and also creates positive alignment of the corner assembly in relation to the glazed panels while allowing for movement due to thermal expansion/contraction. Moreover, the gaskets 256 help prevent air or water infiltration. Furthermore, in combination with the extensions 222 being received within the corresponding receptacles 224, as discussed above, the corner assembly is locked into place between the adjacent first and second wall sections 118a,b (FIG. 1).

Advantageously, the box corner assembly 202 may be assembled by an installer from the interior of the building, as opposed to conventional box corners that must be installed from the exterior of the building. Moreover, the strut 214 adds lateral strength that helps provide enhanced structural strength (wind load deflection) as compared to conventional box corners. All the parts of the box corner assembly 202 can be located and fit together to provide a compact assembly as compared to conventional box corners, which are often misaligned or offset.

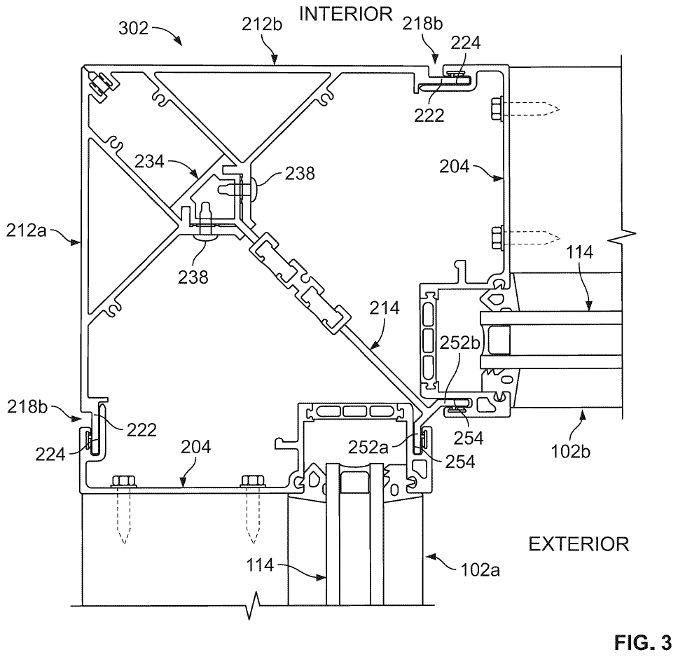

FIG. 3 is a cross-sectional top view of another example box corner assembly 302, according to one or more additional embodiments of the present disclosure. The box corner assembly 302 may be similar in some respects to the box corner assembly 202 of FIG. 2, and therefore may be best understood with reference thereto, where like numerals will represent like components not described again in detail. Similar to the box corner assembly 202, the box corner assembly 302 may form part of the system 100 (FIG. 1) and, therefore, may be operatively coupled to the first and second glazing units 102a,b. Unlike the box corner assembly 202 of FIG. 2, however, the box corner assembly 302 comprises an “inside” box corner, where the panels 114 of the glazing units 102a,b are arranged adjacent to and otherwise facing the exterior of the building, and the glazing units 102a,b converge on the box corner assembly 302 in a concave or inwardly protruding geometry.

Similar to the box corner assembly 202 of FIG. 2, the box corner assembly 302 includes the first and second corner extrusions 212a,b and the strut 214, as generally described above. Furthermore, the corner extrusions 212a,b may each be operatively coupled to the strut 214 at the head 234, as generally described above, and may be positively engaged with the head 234 before the two component parts are secured together using the mechanical fasteners 238, as discussed above.

Moreover, the extension 222 provided at the tail end 218b of each base 216 may be receivable within the corresponding receptacle 224 defined in each mullion 204, as discussed above, and the first and second flanges 252a,b of the strut 214 may be receivable within corresponding the receptacles 254 defined in each mullion 204. This helps secure the box corner assembly 302 to the glazing panels 102a,b.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, uphole, downhole and the like are used in relation to the illustrative embodiments as they are depicted in the figures, the upward direction being toward the top of the corresponding figure and the downward direction being toward the bottom of the corresponding figure, the uphole direction being toward the surface of the well and the downhole direction being toward the toe of the well.

What is claimed is:

1. A fenestration system, comprising:
a first wall section extending in a first direction and including a first glazing unit attached to a first mullion;
a second wall section extending in a second direction different from the first direction and including a second glazing unit attached to a second mullion; and
a box corner assembly interposing and operatively coupling the first and second glazing units, the box corner assembly including:
first and second corner extrusions, each corner extrusion including a base that provides opposing apex and tail ends, the apex end of each corner extrusion being operatively coupled to each other, the tail end of the base of the first corner extrusion being operatively coupled to the first mullion, and the tail end of the base of the second corner extrusion being operatively coupled to the second mullion; and
a strut including a head operatively coupled to the first and second corner extrusions, and a stem extending from the head and being operatively coupled to the first and second mullions.

2. The fenestration system of claim 1, wherein the first and second wall sections form part of a storefront framing system, a window wall system, or a curtain wall system.

3. The fenestration system of claim 1, wherein the first and second directions are angularly offset from each other by about 45°to about 185°.

4. The fenestration system of claim 1, wherein the box corner assembly comprises an outside box corner and the first and second wall sections converge on the box corner assembly in a convex and outwardly protruding geometry.

5. The fenestration system of claim 1, wherein the box corner assembly comprises an inside box corner and the first and second wall sections converge on the box corner assembly in a concave and inwardly protruding geometry.

6. The fenestration system of claim 1, wherein the apex end of each corner extrusion is operatively coupled to each other using a gasket arranged at an interface between the apex ends.

7. The fenestration system of claim 1, wherein at least one of the first and second mullions comprises a split mullion.

8. The fenestration system of claim 1, wherein at least one of the first and second mullions comprises a composite profile including an outer section, an inner section, and a thermal break that interposes and operatively couples the outer and inner sections.

9. The fenestration system of claim 1, wherein each tail end provides an extension configured to be received within a receptacle provided by the corresponding first or second mullion.

10. The fenestration system of claim 9, further comprising:
a first gasket arranged at an interface between the receptacle of the first mullion and the tail end of the first corner extrusion; and
a second gasket arranged at an interface between the receptacle of the second mullion and the tail end of the second corner extrusion.

11. The fenestration system of claim 1, wherein each corner extrusion provides a lateral projection that terminates at a foot, and wherein each foot is engageable with the head of the strut, and one or more mechanical fasteners secure the foot to the head.

12. The fenestration system of claim 11, further comprising a lateral tab extending from each corner extrusion and sized to be received within a corresponding channel defined by the head, wherein the foot and the lateral tab of each corner extrusion engage different, non-parallel surfaces of the head, thereby providing positive engagement that temporarily attaches each corner extrusion to the strut.

13. The fenestration system of claim 1, wherein the stem includes a thermal break positioned along its length.

14. The fenestration system of claim 1, wherein the stem includes a first flange receivable within a first receptacle of the first mullion, and a second flange receivable within a second receptacle of the second mullion, and wherein receiving the first and second flanges in the first and second receptacles, respectively, operatively couples the stem to the first and second mullions.

15. A box corner assembly for a fenestration system, comprising:
a first corner extrusion that includes:
a first base having opposing apex and tail ends; and
a first lateral projection extending from the first base and terminating at
a first foot;
a second corner extrusion that includes:
a second base having opposing apex and tail ends, the apex end of each base being operatively coupleable to each other, the tail end of the first base being operatively coupleable to a first wall section of the fenestration system, and the tail end of the second base being operatively coupleable to a second wall section of the fenestration system; and
a second lateral projection extending from the second base and terminating at a second foot; and
a strut including a head operatively coupleable to the first and second feet, and a stem extending from the head.

16. The box corner assembly of claim 15, further comprising one or more gaskets arranged at an interface between the apex ends of each base to operatively couple the apex end of the first base to the apex end of the second base.

17. The box corner assembly of claim 15, further comprising one or more mechanical fasteners to secure the foot of each lateral projection to the head.

18. The box corner assembly of claim 15, further comprising:
one or more first protrusions provided at an interface between the first foot and the head; and
one or more second protrusions provided at an interface between the second foot and the head.

19. The box corner assembly of claim 15, wherein the first corner extrusion provides a first lateral tab extending from the first lateral projection and sized to be received within a first channel defined by the head,
wherein the second corner extrusion provides a second lateral tab extending from the second lateral projection and sized to be received within a second channel defined by the head, and
wherein the first foot and the first lateral tab engage different, non-parallel surfaces of the head, and the second foot and the second lateral tab engage different, non-parallel surfaces of the head, thereby providing positive engagement that temporarily attaches each corner extrusion to the strut.

20. The box corner assembly of claim 15, wherein the stem includes a thermal break positioned along its length.
